(19) United States
(12) Patent Application Publication
(10) Pub. No.: US 2025/0156663 A1
(43) Pub. Date: May 15, 2025

(54) COMPENSATION METHOD FOR CURVED SURFACE PAD PRINTING, CURVED SURFACE PAD PRINTING SYSTEM AND PRINTED MATTER

(71) Applicant: Wistron NeWeb Corporation, Hsinchu (TW)

(72) Inventor: Yu-Kai CHIU, Hsinchu (TW)

(21) Appl. No.: 18/937,234

(22) Filed: Nov. 5, 2024

(30) Foreign Application Priority Data
Nov. 9, 2023 (TW) 112143157

(51) Int. Cl. G06K 15/02; B41F 17/00; B41M 1/40

(52) U.S. Cl. CPC G06K 15/021; B41F 17/001; B41F 17/006; B41M 1/40; G06K 15/1822; G06K 15/1825; G06K 15/1842; G06K 15/1848

(57) ABSTRACT

The compensation method includes an importing step, an analyzing step, an identifying step, a comparing step, and a compensating step. The importing step includes obtaining a template pattern and an initial pad printed image. The analyzing step includes analyzing the initial pad printed image to generate a plurality of sample feature points. The identifying step includes identifying the coordinates of each of the sample feature points to generate corresponding sample feature point coordinates. The comparing step includes comparing the sample feature point coordinates to template sample feature point coordinates to generate a coordinate change result. The compensating step includes generating a compensation pattern based on the coordinate change result and the template pattern.

### RELATED APPLICATIONS

This application claims the benefit of priority to Taiwan Patent Application No. 112143157, filed on Nov. 9, 2023. The entire content of the above identified application is incorporated herein by reference.

### BACKGROUND

### Technical Field

The present disclosure relates to a pad printing method and system, and more particularly, to a compensation method for curved surface pad printing and a curved surface pad printing system.

### Description of Related Art

When general pad printing equipment performs curved surface pad printing on products, the force contact conditions when the pad printing head is pressed down are different from those of a flat ink plate used in normal flat surface pad printing, causing deformation of the pad printing head and resulting in distorted or skewed printed patterns. Additionally, the uneven surface structure (e.g., braille dots, holes) of the product can further exacerbate deformation of the pad printing head at the uneven region.

Existing high-end pad printing equipment with curved surface pad printing technology relies heavily on specialized functional equipment, such as a rotating platform for the product during the pad printing process. However, the high cost of such equipment limits its affordability for manufacturers.

In view of this, the development of a pad printing system that can achieve good curved surface pad printing effects without requiring specialized curved surface pad printing equipment is in dire need for the related industry.

### SUMMARY

In one aspect, the present disclosure provides a compensation method for curved surface pad printing, the compensation method includes an importing step, an analyzing step, an identifying step, a comparing step, and a compensating step. The importing step includes driving a processor to obtain a template pattern and an initial pad printing image, the template pattern includes a plurality of template sample feature points and a plurality of template sample feature point coordinates corresponding to each of the template sample feature points. The analyzing step includes driving the processor to analyze the initial pad printing image to generate a plurality of sample feature points, the sample feature points corresponding to the template sample feature points. The identifying step includes driving the processor to identify the coordinates of each of the sample feature points to generate a plurality of sample feature point coordinates corresponding to the sample feature points. The comparing step includes driving the processor to compare the sample feature point coordinates and the template sample feature point coordinates to generate a coordinate change result. The compensating step includes driving the processor to compute and generate a compensation pattern based on the coordinate change result and the template pattern.

In another aspect, the present disclosure provides a printed matter with a pad printed pattern compensated by the above-mentioned compensation method for curved surface pad printing.

In yet another aspect, the present disclosure provides a curved surface pad printing system that includes a memory, a processor, and a printing device. The memory stores a template pattern, the template pattern includes a plurality of template sample feature points and a plurality of template sample feature point coordinates corresponding to each of the template sample feature points. The processor is connected to the memory and is configured to implement an importing step, an analyzing step, an identifying step, a comparing step, and a compensating step. The importing step includes obtaining the template pattern and an initial pad printing image. The analyzing step includes analyzing the initial pad printing image to generate a plurality of sample feature points, the sample feature points correspond to the template sample feature points. The identifying step includes identifying coordinates of each of the sample feature points to generate a plurality of sample feature point coordinates corresponding to each of the sample feature points. The comparing step includes comparing the sample feature point coordinates and the template sample feature point coordinates to generate a coordinate change result. The compensating step includes computing and generating a compensation pattern based on the coordinate change result and the template pattern. The printing device is connected to the processor and is configured to perform pad printing on a semi-finished product based on the template pattern and the compensation pattern.

### BRIEF DESCRIPTION OF THE DRAWINGS

The present disclosure can be more fully understood by reading the following detailed description of the embodiment, with reference made to the accompanying drawings as follows:

FIG. 1 is a block diagram of a curved surface pad printing system according to a first embodiment of the present disclosure.

FIG. 2 is a block flowchart of a compensation method for curved surface pad printing according to a second embodiment of the present disclosure.

FIG. 3 is a schematic diagram showing an integration of a template pattern and an initial pad printing image in an importing step of the second embodiment in FIG. 2.

FIG. 4 is a schematic diagram showing sample feature points of an initial pad printing image and template sample feature points of a template pattern in the second embodiment in FIG. 2.

FIG. 5 is a schematic diagram showing a compensation pattern generated according to the compensation method for curved surface pad printing in the second embodiment in FIG. 2.

FIG. 6A is a top view of a printed matter in a third embodiment of the present disclosure.

FIG. 6B is a front view of the printed matter in the third embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

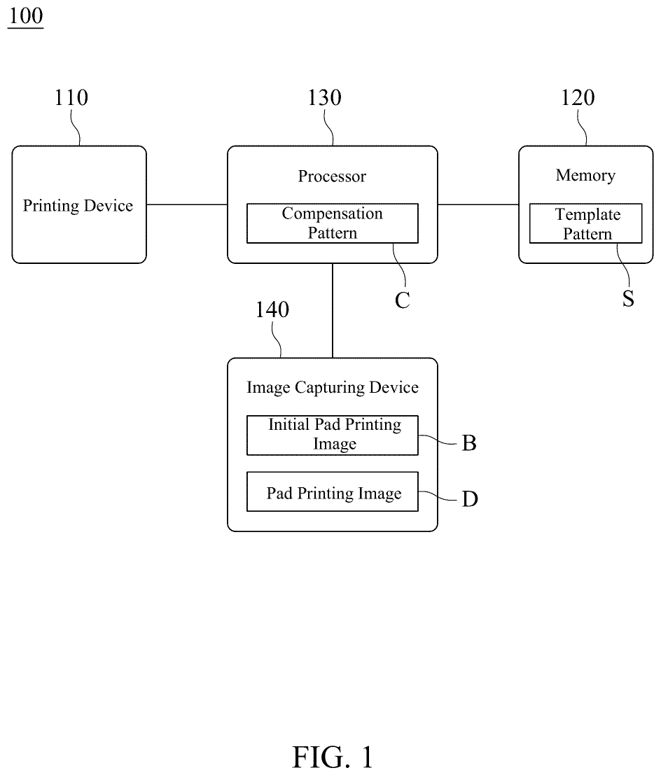

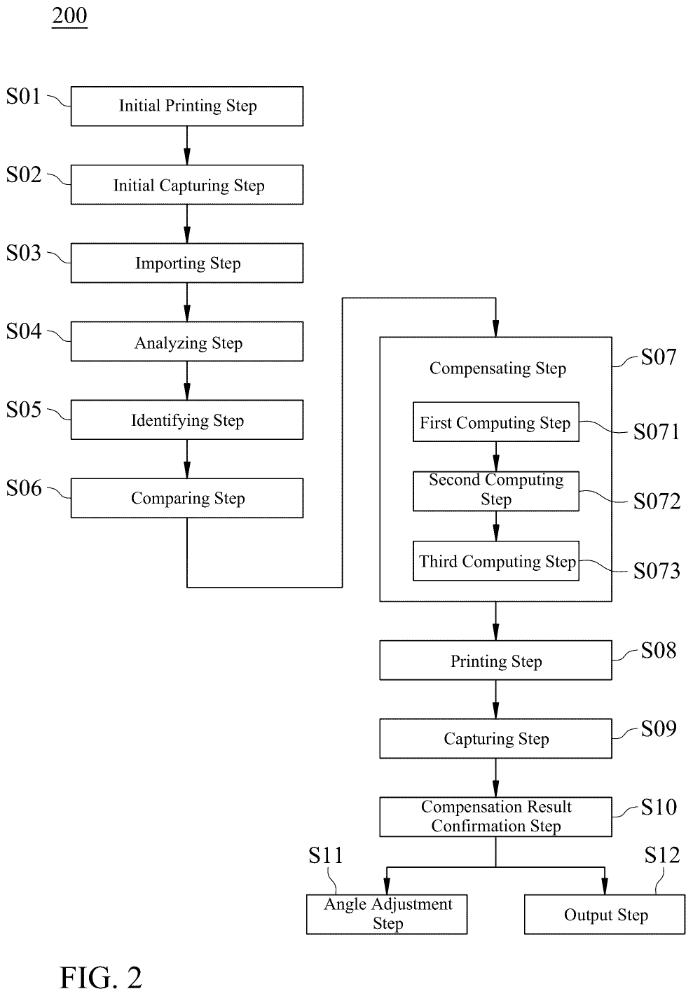

Referring to FIG. 1 and FIG. 2, where FIG. 1 is a block diagram of a curved surface pad printing system 100 according to the first embodiment of the present disclosure; and FIG. 2 is a block flowchart of a compensation method for curved surface pad printing 200 according to the second embodiment of the present disclosure. The curved surface pad printing system 100 is configured to implement the compensation method for curved surface pad printing 200, which compensates for the deformation and skew of the pad printing pattern to achieve good curved surface pad printing effects. It should be noted that, the compensation method for curved surface pad printing 200 of the present disclosure is not limited to being implemented through the curved surface pad printing system 100 of the present disclosure, and the components in the curved surface pad printing system 100 can be arbitrarily integrated into various combinations to perform the functions of the compensation method for curved surface pad printing 200.

In FIG. 1, the curved surface pad printing system 100 includes a printing device 110, a memory 120, a processor 130, and an image capturing device 140. The processor 130 is connected to the printing device 110, the memory 120, and the image capturing device 140. The printing device 110 is used to perform pad printing on a semi-finished product based on a template pattern S to generate an initial printed matter, and to perform pad printing on the semi-finished product based on a compensation pattern C to generate a compensated printed matter. The memory 120 is used to store the template pattern S. The image capturing device 140 is used to capture the initial printed matter and the compensated printed matter, generating an initial pad printing image B and a pad printing image D, respectively. The processor 130 is used to implement the compensation method for curved surface pad printing 200, which can perform curved surface compensation based on the initial pad printing image B to generate the compensation pattern C, and can confirm whether to further adjust the angle of the compensation pattern C based on the pad printing image D, thereby achieving the best compensation effect. In the first embodiment, the memory 120 can be a random access memory (RAM) or other types of dynamic storage devices for storing information and instructions for execution by the processor 130; the processor 130 can be a processor, microprocessor, central processing unit (CPU), computer, mobile device processor, cloud processor, or other electronic computing processors; the image capturing device 140 can be a camera or a mobile phone camera, but the present disclosure is not limited thereto.

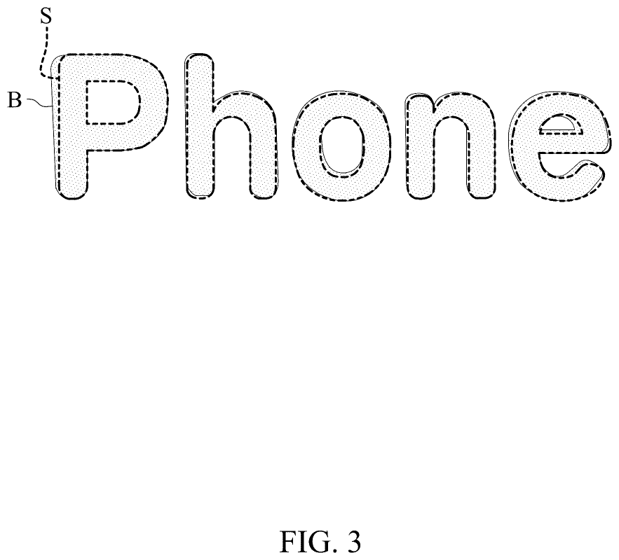

Referring to FIG. 1 to FIG. 3, where FIG. 3 is a schematic diagram showing the integration of the template pattern S and the initial pad printing image B in the importing step S03 of the second embodiment in FIG. 2. The compensation method for curved surface pad printing 200 includes an initial printing step S01, an initial capturing step S02, an importing step S03, an analyzing step S04, an identifying step S05, a comparing step S06, and a compensating step S07, which are executed sequentially. The initial printing step S01 includes driving the printing device 110 to perform pad printing on the semi-finished product based on the template pattern S to generate the initial printed matter. The initial capturing step S02 includes driving the image capturing device 140 to capture the initial printed matter, generating the initial pad printing image B. The importing step S03 includes driving the processor 130 to obtain the template pattern S from the memory 120 and the initial pad printing image B from the image capturing device 140, and driving the processor 130 to integrate the template pattern S and the initial pad printing image B. The template pattern S can be a line frame or a two-dimensional pattern of a printed pattern and includes a plurality of template sample feature points P1 and corresponding template sample feature point coordinates (the template sample feature points P1 are not shown in FIG. 3).

More specifically, in FIG. 3, the initial pad printing image B is the printed pattern “Phone” on the initial printed matter, and the template pattern S is the line frame of the printed pattern “Phone”. In the importing step S03, the processor 130 overlays the template pattern S on the initial pad printing image B to integrate the template pattern S and the initial pad printing image B. At this time, it can be observed that the printed pattern on the initial printed matter is skewed compared to the template pattern S.

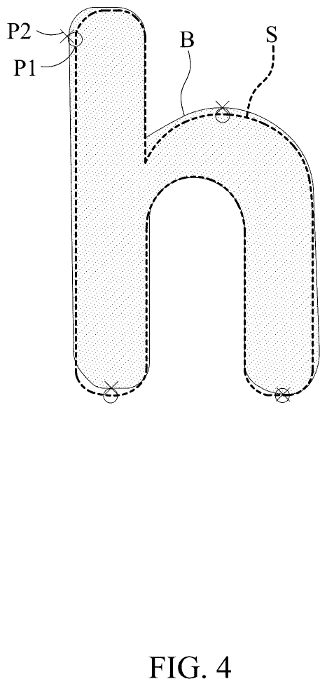

Referring to FIG. 1 to FIG. 4, where FIG. 4 is a schematic diagram showing the sample feature points P2 of the initial pad printing image B and the template sample feature points P1 of the template pattern S in the second embodiment in FIG. 2. The analyzing step S04 includes driving the processor 130 to analyze the initial pad printing image B to generate a plurality of sample feature points P2, which correspond to the template sample feature points P1 of the template pattern S. The template sample feature points P1 and the sample feature points P2 include at least one movable point and at least one fixed point. The at least one movable point can be a curve vertex, a point with the greatest curvature change, or an intersection of a rounded corner and a straight line in the template pattern S. The at least one fixed point can be the highest or lowest point in the template pattern S. In the second embodiment, the number of template sample feature points P1 and sample feature points P2 is 4, but the present disclosure is not limited thereto.

In FIG. 4, taking the printed pattern “h” as an example, among the template sample feature points P1 and the sample feature points P2, the movable points corresponding to the printed pattern “h” are the intersection of the rounded corner and the straight line on the upper left and the curve vertex on the upper right; the fixed point corresponding to the printed pattern “h” is the lowest point in the template pattern S on the lower right.

The identifying step S05 includes driving the processor 130 to identify the coordinates of each of the sample feature points P2, generating corresponding sample feature point coordinates. The comparing step S06 includes driving the processor 130 to compare each of the sample feature point coordinates and each of the template sample feature point coordinates to generate a coordinate change result. The compensating step S07 includes driving the processor 130 to compute and generate the compensation pattern C based on the coordinate change result and the template pattern S, thereby completing curved surface pad printing compensation. In the second embodiment, the template sample feature point coordinates and the sample feature point coordinates are both two-dimensional coordinates.

The compensating step S07 further includes a first computing step S071, a second computing step S072, and a third computing step S073. The first computing step S071 includes driving the processor 130 to compute and generate a skew matrix based on the coordinate change result using the linear mapping method. The second computing step S072 includes driving the processor 130 to compute and generate a generalized inverse matrix based on the skew matrix. The third computing step S073 includes driving the processor 130 to generate the compensation pattern C based on the generalized inverse matrix and the template pattern S, and more particularly, the processor 130 multiplies the generalized inverse matrix with the template pattern S to generate the compensation pattern C.

In specific, the derivation of the skew matrix and the compensation pattern C is as follows:

Assume that the number of template sample feature points P1 and sample feature points P2 defined by the template pattern S and the initial pad printing image B is 4. The coordinate matrices of the template sample feature points P1 in the template pattern S and the sample feature points P2 in the initial pad printing image B are as follows:

$$A = [ \begin{matrix}{P}_{1 x} & {P}_{2 x} & {P}_{3 x} & {P}_{4 x} \\ {P}_{1 y} & {P}_{2 y} & {P}_{3 y} & {P}_{4 y}\end{matrix} ] ;$$

$${A}^{′} = [ \begin{matrix}{{P}^{′}}_{1 x} & {{P}^{′}}_{2 x} & {{P}^{′}}_{3 x} & {{P}^{′}}_{4 x} \\ {{P}^{′}}_{1 y} & {{P}^{′}}_{2 y} & {{P}^{′}}_{3 y} & {{P}^{′}}_{4 y}\end{matrix} ] .$$

A is the coordinate matrix of the template sample feature points P1 in the template pattern S, and A′ is the coordinate matrix of the sample feature points P2 in the initial pad printing image B.

The skew matrix is calculated as follows:

$$F = {A}^{′} {{A}^{T} ( {A}^{′} {A}^{T} )}^{- 1} .$$

F is the skew matrix, and A^{T} is the transpose of the coordinate matrix of the template sample feature points P1.

The compensation pattern C is calculated as follows:

$$C = {F}^{- 1} A .$$

C is the compensation pattern, and F⁻¹ is the generalized inverse matrix of the skew matrix.

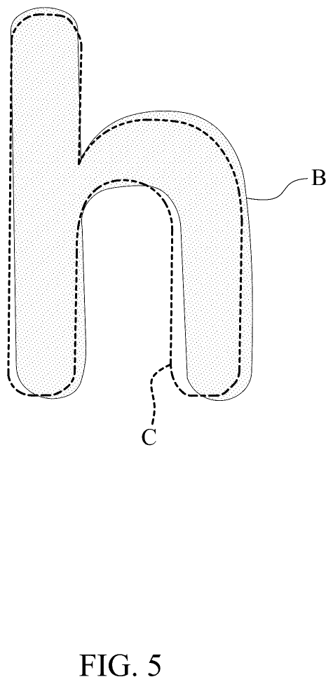

Referring to FIG. 1 to FIG. 5. FIG. 5 is a schematic diagram showing the compensation pattern C generated according to the compensation method for curved surface pad printing 200 in the second embodiment in FIG. 2. Taking the coordinate change result between the initial pad printing image B and the template pattern S as shown in FIG. 4 as an example.

In the first computing step S071, the coordinate change result is computed using the linear mapping method to generate a skew matrix

$$F = \begin{matrix}1.008785 & - 0.015616 \\ 0.013826 & 1.013834\end{matrix} .$$

In the second computing step S072, the generalized inverse matrix of the skew matrix is computed, resulting in the generalized inverse matrix

$${F}^{- 1} = \begin{matrix}0.991082 & 0.015265 \\ - 0.013516 & 0.986146\end{matrix} .$$

In the third computing step S073, the generalized inverse matrix is multiplied with the template pattern S to generate the compensation pattern C. It can be observed from FIG. 4, the upper half of the initial pad printing image B is skewed to the left and upward compared to the template pattern S. It can be observed from FIG. 5, after the compensation calculation, the upper half of the compensation pattern C is slightly skewed to the right compared to the initial pad printing image B, thereby achieving the skew compensation effect.

Referring to FIG. 1 to FIG. 2, the compensation method for curved surface pad printing 200 can also include a printing step S08, a capturing step S09, a compensation result confirmation step S10, an angle adjustment step S11, and an output step S12. The printing step S08 and the capturing step S09 are sequentially executed after the compensating step S07, and the angle adjustment step S11 and the output step S12 are executed after the compensation result confirmation step S10. The printing step S08 includes driving the printing device 110 to perform pad printing on the semi-finished product based on the compensation pattern C to generate the compensated printed matter. The capturing step S09 includes driving the image capturing device 140 to capture the compensated printed matter, generating a pad printing image D.

The compensation result confirmation step S10 includes driving the processor 130 to measure the skew degree of the printed pattern in the pad printing image D and confirm whether an angle difference between the pad printing image D and the template pattern S is greater than or equal to a threshold value to generate a confirmation result, and output the compensation pattern C based on the confirmation result. When the confirmation result is affirmative, the angle adjustment step S11 is executed. The angle adjustment step S11 includes driving the processor 130 to rotate and correct the compensation pattern C based on the angle difference and re-executing the printing step S08, the capturing step S09, and the compensation result confirmation step S10. When the confirmation result is negative, the output step S12 is executed. The output step S12 includes outputting the compensation pattern C as the final compensation pattern to complete the curved surface pad printing compensation.

It should be noted that, the number and position of the template sample feature points P1 and the sample feature points P2 will have a slight impact on the calculation of the skew matrix in the compensating step S07, and there is a possibility that the compensation pattern C may be over-compensated or have an angular difference. Therefore, the compensation result confirmation step S10 is necessary to confirm and further optimize the compensation pattern C.

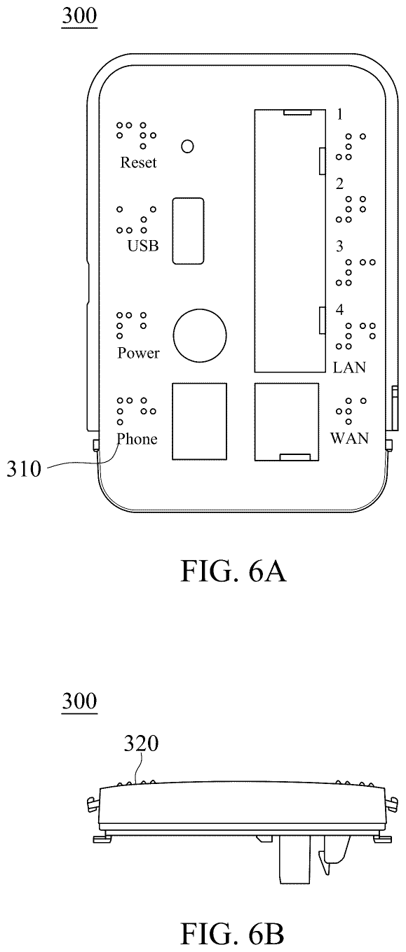

Referring to FIG. 1, FIG. 2, FIG. 6A, and FIG. 6B, where FIG. 6A is a top view of a printed matter 300 in the third embodiment of the present disclosure; and FIG. 6B is a front view of the printed matter 300 in the third embodiment of the present disclosure. The printed matter 300 has a printed pattern 310, and part of the printed pattern 310 is located at or near a non-flat surface 320 of the printed matter 300. The non-flat surface 320 can be a curved surface, a raised point, or a hole structure. In the third embodiment, the printed matter 300 is a compensated printed matter produced by pad printing the semi-finished product according to the compensation pattern C by the printing device 110 after being compensated by the compensation method for curved surface pad printing 200 in the aforementioned first and second embodiments.

In view of the above, the present disclosure has the following advantages: first, by calculating the coordinate change result between the initial pad printing image and the template pattern to generate the compensation pattern, the compensation for curved surface pad printing can be quickly achieved, providing good curved surface pad printing effects. Second, by improving the skew and deformation issues of curved surface pad printing through the compensation pattern, it can be applied to general pad printing equipment without requiring specialized curved surface pad printing equipment, thereby significantly reducing costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A compensation method for curved surface pad printing, the compensation method comprising:
an importing step, comprising driving a processor to obtain a template pattern and an initial pad printing image, the template pattern comprising a plurality of template sample feature points and a plurality of template sample feature point coordinates corresponding to each of the plurality of template sample feature points;
an analyzing step, comprising driving the processor to analyze the initial pad printing image to generate a plurality of sample feature points, the plurality of sample feature points corresponding to the plurality of template sample feature points;
an identifying step, comprising driving the processor to identify coordinates of each of the plurality of sample feature points to generate a plurality of sample feature point coordinates corresponding to each of the plurality of sample feature points;
a comparing step, comprising driving the processor to compare the plurality of sample feature point coordinates and the plurality of template sample feature point coordinates to generate a coordinate change result; and
a compensating step, comprising driving the processor to compute and generate a compensation pattern based on the coordinate change result and the template pattern.

2. The compensation method for curved surface pad printing of claim 1, wherein the compensating step further comprises:
a first computing step, comprising driving the processor to compute and generate a skew matrix based on the coordinate change result using a linear mapping method;
a second computing step, comprising driving the processor to compute and generate a generalized inverse matrix based on the skew matrix; and
a third computing step, comprising driving the processor to generate the compensation pattern based on the generalized inverse matrix and the template pattern.

3. The compensation method for curved surface pad printing of claim 2, wherein, in the third computing step, the processor multiplies the generalized inverse matrix with the template pattern to generate the compensation pattern.

4. The compensation method for curved surface pad printing of claim 1, wherein the plurality of template sample feature points and the plurality of sample feature points comprise at least one movable point and at least one fixed point;
wherein, the at least one movable point is a curve vertex, a point with greatest curvature change, or an intersection of a rounded corner and a straight line in the template pattern, and the at least one fixed point is a highest or lowest point in the template pattern.

5. The compensation method for curved surface pad printing of claim 1, wherein the importing step further comprises driving the processor to integrate the template pattern and the initial pad printing image.

6. The compensation method for curved surface pad printing of claim 1, further comprising:
a printing step, comprising driving a printing device to perform pad printing on a semi-finished product based on the compensation pattern to generate a compensated printed matter; and
a capturing step, comprising driving an image capturing device to capture the compensated printed matter to generate a pad printing image.

7. The compensation method for curved surface pad printing of claim 6, further comprising:
a compensation result confirmation step, comprising driving the processor to confirm whether an angle difference between the pad printing image and the template pattern is greater than or equal to a threshold value to generate a confirmation result, and output the compensation pattern based on the confirmation result;
wherein, when the confirmation result is negative, the compensation pattern is output to complete curved surface pad printing compensation.

8. The compensation method for curved surface pad printing of claim 7, wherein, when the confirmation result is affirmative, the compensation method further comprises an angle adjustment step, comprising driving the processor to rotate and correct the compensation pattern based on the angle difference, and the compensation method re-executes the printing step, the capturing step, and the compensation result confirmation step.

9. The compensation method for curved surface pad printing of claim 1, further comprising:
an initial printing step, comprising driving a printing device to perform pad printing on a semi-finished product based on the template pattern to generate an initial printed matter; and
an initial capturing step, comprising driving an image capturing device to capture the initial printed matter to generate the initial pad printing image.

10. A printed matter with a pad printed pattern compensated by the compensation method for curved surface pad printing of claim 1.

11. The printed matter of claim 10, wherein part of the pad printed pattern is located at or near a non-flat surface of the printed matter.

12. A curved surface pad printing system, comprising:
a memory, storing a template pattern, the template pattern comprising a plurality of template sample feature points and a plurality of template sample feature point coordinates corresponding to each of the plurality of template sample feature points;
a processor, connected to the memory, and configured to implement the following steps:
an importing step, comprising obtaining the template pattern and an initial pad printing image;
an analyzing step, comprising analyzing the initial pad printing image to generate a plurality of sample feature points, the plurality of sample feature points corresponding to the plurality of template sample feature points;
an identifying step, comprising identifying coordinates of each of the plurality of sample feature points to generate a plurality of sample feature point coordinates corresponding to each of the plurality of sample feature points;
a comparing step, comprising comparing the plurality of sample feature point coordinates and the plurality of template sample feature point coordinates to generate a coordinate change result; and
a compensating step, comprising computing and generating a compensation pattern based on the coordinate change result and the template pattern; and
a printing device, connected to the processor and configured to perform pad printing on a semi-finished product based on the template pattern and the compensation pattern.

13. The curved surface pad printing system of claim 12, wherein the compensating step further comprises:
a first computing step, comprising computing and generating a skew matrix based on the coordinate change result using a linear mapping method;
a second computing step, comprising computing and generating a generalized inverse matrix based on the skew matrix; and
a third computing step, comprising generating the compensation pattern based on the generalized inverse matrix and the template pattern.

14. The curved surface pad printing system of claim 13, wherein, in the third computing step, the processor multiplies the generalized inverse matrix with the template pattern to generate the compensation pattern.

15. The curved surface pad printing system of claim 12, wherein the plurality of template sample feature points and the plurality of sample feature points comprise at least one movable point and at least one fixed point;
wherein, the at least one movable point is a curve vertex, a point with greatest curvature change, or an intersection of a rounded corner and a straight line in the template pattern, and the at least one fixed point is a highest or lowest point in the template pattern.

16. The curved surface pad printing system of claim 12, wherein the importing step further comprises integrating the template pattern and the initial pad printing image.

17. The curved surface pad printing system of claim 12, further comprising:
an image capturing device, connected to the processor and configured to capture an initial printed matter and a compensated printed matter, produced by pad printing by the printing device, to generate the initial pad printing image and a pad printing image, respectively.

18. The curved surface pad printing system of claim 17, wherein the processor is further configured to implement the following steps:
a compensation result confirmation step, comprising confirming whether an angle difference between the pad printing image and the template pattern is greater than or equal to a threshold value to generate a confirmation result, and outputting the compensation pattern based on the confirmation result;
wherein, when the confirmation result is negative, the compensation pattern is output to complete curved surface pad printing compensation.

19. The curved surface pad printing system of claim 18, wherein when the confirmation result is affirmative, the processor is further configured to implement the following step:
an angle adjustment step, comprising rotating and correcting the compensation pattern based on the angle difference.
